(19) United States
(12) Patent Application Publication
(10) Pub. No.: US 2026/0107881 A1
(43) Pub. Date: Apr. 23, 2026

(54) KNIVE GRIPPER SYSTEM FOR BALERS

(71) Applicant: DEERE & COMPANY, MOLINE, IL (US)

(72) Inventors: ALEXIS FILLOUX, Chargey-Les-Gray (FR); Florian Benoit-Guerindon, TALMAY (FR)

(21) Appl. No.: 19/330,019

(22) Filed: Sep. 16, 2025

(30) Foreign Application Priority Data
Oct. 23, 2024 (EP) 24208353.3

(51) Int. Cl. A01F 29/09

(52) U.S. Cl. CPC A01F 29/095

(57) ABSTRACT

The disclosure relates to a cutter for a cutting device for an agricultural harvester, comprising a cutter body with a first side and a second side. The cutter body has a cutting region with a cutting edge which extends along a longitudinal axis of the cutter body. The cutter comprises a pivot region with a first recess and a positioning region with a second recess for arrangement of the cutter on the cutting device of the agricultural harvester. The first recess is configured for receiving a pivot shaft of the cutting device, and the second recess is configured for receiving a positioning device. The cutter has at least a first and second hole.

### CROSS-REFERENCE TO RELATED APPLICATIONS

This application claims the benefit of European Patent Application EP 24208353.3, filed on October 23, 2024, the disclosure of which is hereby incorporated by reference.

### TECHNICAL FIELD

The disclosure generally relates to a cutter device for an agricultural harvester.

### BACKGROUND

In agricultural harvesters, such as balers and loading wagons, the agricultural crop must be cut into shorter pieces prior to storage. For this, cutting devices are used which have a number of cutters, wherein the cutters are arranged side-by-side and extend into a channel in which the crop is conveyed, whereby the crop is cut between adjacent pairs of cutters. To change the cutting length, in each case a number of cutters is moved into or out of the channel to change the gap between adjacent pairs of the cutters.

### SUMMARY

According to the disclosure, a cutter is proposed for a cutting device for an agricultural harvester, for example, a loading wagon or a baler. The cutter comprises a cutter body with a first side and a second side. The first and second sides may each define a plane and/or the first and second sides may each be configured as a plane. The first and second planes may be parallel planes. The cutter body has a cutting region with a cutting edge, wherein the cutting edge extends along a longitudinal axis of the cutter body. In addition, the cutter, for example, the cutter body, comprises a pivot region with a first recess or a first cutout for arrangement and/or reception of the cutter on and/or in the cutting device of the agricultural harvester.

Moreover, the cutter, for example, the cutter body, comprises a positioning region with a second recess or a second cutout for arrangement and/or reception of the cutter on and/or in the cutting device of the agricultural harvester. The first recess is configured for receiving a pivot shaft of the cutting device. The second recess is configured for receiving a positioning device of the cutting device, for example, a lever of the positioning device of the cutting device. In addition, the cutter, for example, the cutter body, comprises at least a first and second hole, for example, one first hole and one second hole.

The cutter comprises the cutter body. The cutter body may consist of a hard material, such as steel, in order to withstand repeated loads when cutting crops. In addition, the cutter body may comprise a support structure for the cutting region, for example, the cutting edge.

The cutter body comprises the first side and the second side, wherein the second side is arranged on the other side of the cutter body from the first side. The first side and the second side may be level or flat, so that the first side can run parallel to the second side. The distance between the first and second sides, for example, the thickness of the cutter body, may be between 1 and 20 mm, preferably between 2 and 10 mm, more preferably between 3 to 8 mm. In one example implementation, the cutter body may be approximately 5 millimetres thick.

The pivot region, for example, the first recess, and the positioning region, for example, the second recess, of the cutter or cutter body may have a non-cutting outer contour, for example, an outer contour without cutting edge. The pivot region, for example, the first recess, and the positioning region, for example, the second recess, may be open or closed towards the outer contour of the cutter or cutter body. The first and second hole may have no connection to the outer contour of the cutter or cutter body, for example, may be arranged and/or received completely in the cutter body. The pivot region, for example, the first recess or the first cutout, may be arranged on a first edge of the cutter or the cutter body, which may be a non-cutting edge. The first recess or the first cutout may be open towards the outer contour of the first edge. The first hole may be arranged at or in the region of a second edge of the cutter or the cutter body, which may be a non-cutting edge. The first hole may not be open towards the outer contour of the second edge. The first hole may be arranged outside the pivot region and positioning region. The first hole may be arranged diametrically opposed to and/or opposite the pivot region. The second edge may be arranged opposite and/or parallel to and/or diametrically opposed to the first edge. The cutting region, for example, the cutting edge, may be arranged on a third edge of the cutter or the cutter body, or the third edge may at least partially be formed as a cutting edge. The positioning region, for example, the second recess or the second cutout, may be arranged on a fourth edge of the cutter or the cutter body, which may be a non-cutting edge. The second recess or the second cutout may be open towards the outer contour of the fourth edge. The second hole may be arranged at or in the positioning region and/or the fourth edge. The second hole may not be open towards the outer contour of the second edge. The third edge may be arranged opposite and/or parallel to and/or diametrically opposed to the fourth edge.

The cutter may have at least two holes, wherein the first hole may be arranged diametrically opposed to and/or opposite the pivot region. Thus, advantageously, when a force acts on the first hole, for example in the direction of the cutting region or the cutting edge on the cutter, the cutter can be pivotable around the pivot region.

In one implementation of the disclosure, the first hole is configured for receiving a lever element. In addition, the first hole may be smaller than the second hole. Thus, advantageously, when a force acts via the lever element on the first hole in the direction of the cutting region or the cutting edge on the cutter, the cutter can be pivotable around the pivot region.

In one implementation of the disclosure, the first and second recesses are open towards the outer contour of the cutter or the cutter body, and/or the first and second holes are closed towards the outer contour of the cutter.

In one implementation of the disclosure, the cutting edge or the cutting region may have a plurality of teeth, each of which comprises or contains a leading edge and a trailing edge, wherein the leading edge extends from the trailing edge of an adjacent tooth, and comprises or contains a plurality of valleys. Each of the plurality of teeth may originate from a splined shaft which is defined by the cutter body. The splined shaft may extend along the longitudinal axis of the cutter body. Each of the teeth may have a width "w", which can generally be defined by a recessed portion or a valley of the cutter body. The recessed portions of each tooth may extend from the splines to the cutting edge. Each of the recessed portions may have a surface, which may be inclined. Due to the inclination of this surface, the cutting edge of each tooth may also be inclined, so as to improve the cutting process.

The disclosure furthermore relates to a cutting device for an agricultural harvester, comprising at least one cutter, for example, two or more cutters. The cutter is arranged in a channel through which the crop can flow in normal operation in a flow direction. The cutter is connectable or connected, preferably pivotably connectable or connected and releasably connectable or connected, to the cutting device, for example, a frame of the cutting device, so as to be pivotable around a pivot axis extending transversely to the channel. For example, the cutter or cutters may be hinge-mounted on the cutting device, For example, on the frame of the cutting device, so as to be pivotable around a pivot axis extending transversely to the channel. The frame of the cutting device may also be the frame of the harvester, for example, the baler, or baler frame.

The cutting device furthermore comprises a positioning device for setting and/or adjusting the cutter or cutters. The positioning device is settable and/or adjustable, for example, movable, between a first position, in which the positioning device sets and/or adjusts, for example, positions and/or holds, the cutter or cutters in an active position in which the cutter extends into the channel or the cutters extend into the channel, and a second position, in which the positioning device sets and/or adjusts, for example, positions and/or holds, the cutter or cutters in the non-active position, in which the cutter is pivoted out of the channel or the cutters are pivoted out of the channel, for example, retracted from the channel, and a third position, in which the positioning device is detached from the cutter or cutters and/or is not in engagement with the cutter or cutters, so as to allow a movement of the cutter or cutters independently of the positioning device.

The cutter or cutters may be separable or detachable from the cutting device when the positioning device is in the third position. For example, the cutter or cutters may be separable or detachable from the pivot shaft when the positioning device is in the third position, and a force acts on the cutter, for example, the cutter body, in the direction of the cutting region or the cutting edge, from or in the first hole. In addition, the position of the cutter or cutters may be settable and/or adjustable by means of the positioning device.

The positioning device may be designed and/or arranged and/or configured such that it is in engagement with the cutter or cutters and prevents a movement of the cutter or cutters independently of the positioning device, when the positioning device is in the first and/or second position and in intermediate positions between the first and second positions. Two or more cutters, or a number of cutters, may be arranged next to one another, for example, in the flow direction, transversely to the channel through which crop can flow. The longitudinal axis of the cutter body, for example, the cutting region and/or the cutting edge, may be arranged or extend in the flow direction, transversely or orthogonally to the channel through which crop can flow. The longitudinal axis of the cutter body, for example, the cutting region and/or the cutting edge, may be arranged or extend transversely or orthogonally to the pivot axis. The first and second sides, for example, the first and second planes, may be arranged or extend transversely or orthogonally to the pivot axis. The pivot region, for example, the first recess, may be arranged upstream, for example, in the flow direction, in the channel through which crop can flow. The first hole may be arranged downstream, for example, in the flow direction, in the channel through which crop can flow. The flow direction may be oriented and/or arranged orthogonally and/or transversely to the pivot axis. The positioning region, for example, the second recess, may be arranged, for example, in the flow direction, on a side facing away from the channel through which crop can flow. The second hole may be arranged, for example, in the flow direction, on a side facing away from the channel through which crop can flow. The cutting device may comprise a rotor, for example, a rotor with a plurality of tines. The rotor may be rotatable so as to transport an agricultural crop along the channel. Alternatively or additionally, for controlling the movement of the cutter or cutters, the positioning device may be movable between the first and second and third positions and/or into the first and second and third positions. In other words, the cutter or the cutters may be movable by means of the positioning device; for example, the positioning device may be movable between the first and second and third positions and/or into the first and second and third positions. In the first position, in which the cutter extends into the channel or the cutters extend into the channel, the positioning device can interact with the rotor to cut the crop.

The positioning device, for example, below the rotor, may comprise a rigid wall, preferably an underfloor, particularly preferably a metal sheet. The crop can be transported along the top of the wall. Accordingly, the channel through which the crop is conveyed is situated between the wall and the rotor. In the active position, the cutter or cutters may extend in and/or into the channel through slots in the wall. In the inactive position, the cutter or cutters may be withdrawn from the channel, for example, retracted from the channel, out of the slots in the wall.

The cutting device offers the advantage that removal of the cutter is easier when the positioning device is in the third position. The cutter or cutters can be easily removed by a force, which may act at or in the first hole, on the cutter, for example, the cutter body, in the direction of the cutting region or the cutting edge.

In one implementation of the disclosure, the cutting device comprises a pivot shaft. The pivot axis may be formed or defined by the pivot shaft. In addition, the cutter or cutters may be separable or detachable from the pivot shaft when the positioning device is in the third position. For example, the cutter or cutters may be separable or detachable from the pivot shaft when the positioning device is in the third position and a force acts on the cutter, for example the cutter body, in the direction of the cutting region or the cutting edge. For example, on the side of the cutter or cutters lying upstream in the channel, the cutter or cutters may be hinge-mounted on the cutting device, for example, on a frame of the cutting device, so as to be pivotable around or at the pivot shaft which is received by the first recess of the cutter, for example, of the respective cutters. The pivot shaft may be received by the first recess of the cutter or the first recess of the respective cutter. The pivot shaft may be arranged in the first recess or in the first recess of the respective cutter.

In one implementation of the disclosure, the pivot shaft and/or the cutter have a locking formation which, in a first configuration, locks the cutter on the pivot shaft and, in a second configuration, allows a separation of the cutter from the pivot shaft. The pivot shaft and the cutter may also have a complementary locking formation which, in the first configuration, locks the cutter on the pivot shaft and, in a second configuration, allows a separation of the cutter from the pivot shaft. The pivot shaft and/or the cutter may be adjustable between the first configuration and the second configuration by rotation, for example, relative rotation, of the cutter and/or the pivot shaft. The pivot shaft may, for example, have flattened regions which interact with the first recess, for example, with a complementarily formed first recess, in the cutter. For example, the pivot shaft, for example, the flattened regions of the pivot shaft, can pass through the first recess when it is in specific position.

In one implementation of the disclosure, in the first position and/or the second position and in all intermediate positions between the first and the second positions, the positioning device is connected to the positioning region of the cutter, for example, the cutter body, preferably the second recess, and/or is in engagement with the positioning region and/or is at least partially received in or by the second recess. For example, in the first position and/or the second position and in all intermediate positions between the first and the second positions, the positioning device may be connected to the positioning region of the cutter, for example, the cutter body, the second recess of the cutter, for example, the second recess of the respective cutter; preferably, it may be in engagement with and/or at least partially received by the second recess. The positioning device may be configured that the positioning device is connected to, and may come into engagement with the cutter, preferably the cutter body, particularly preferably the second recess.

The positioning device and/or the cutter, preferably the second recess, may have an engagement formation, for example, a complementary engagement formation. If the cutting device comprises several cutters, the second recess of the respective cutter may have an engagement formation, for example, a complementary engagement formation. The engagement formation, for example, the complementary engagement formation, may be configured so as to maintain the engagement between the positioning device and the cutter, preferably the cutter body, particularly preferably the second recess, in the first and second positions and all intermediate positions between the first and second positions, and to allow a release of the positioning device from the cutter, preferably the cutter body, particularly preferably the second recess, in the third position. Preferably, the engagement formation may be configured such that it limits the relative movement between the positioning device and the cutter, preferably the cutter body, particularly preferably the second recess, in a tangential direction relative to the pivot axis, and/or allows a relative movement of the cutter in a radial direction relative to the pivot axis.

The second recess may comprise a slot which a lever or an engagement element of the positioning device engages. The slot may run substantially parallel to the fourth edge of the cutter, for example, the cutter body. The second recess, for example, the engagement formation, may comprise the slot. The slot may be connected to the second recess or be formed as part of the second recess. The slot may run substantially parallel to the longitudinal axis of the cutter. The positioning device may comprise an engagement element which engages in the slot. For example, the engagement element may be a pin.

In one implementation of the disclosure, the positioning device comprises a switching shaft and a lever. The number of levers corresponds to the number of cutters if the cutting device comprises two or more cutters. If the cutting device comprises two or more cutters, a lever may be assigned to each of the cutters. In the first position and/or the second position and in all intermediate positions between the first and second positions, the lever may be connected to the positioning region of the cutter, preferably the cutter body, particularly preferably the second recess, and/or in engagement with the positioning region and/or at least partially received in the second recess. For example, in the first position and the second position and all intermediate positions between the first and the second positions, the positioning device, for example, the lever assigned to the respective cutter, may be connected to the positioning region of the cutter, for example, the cutter body, the second recess of the cutter, for example, the second recess of the respective cutter; preferably, it may be in engagement with and/or be at least partially received by the second recess, for example, of the respective cutter. The lever may be movable between the first position, in which it holds its assigned cutter in an active position in which it extends into the channel in order to cut the crop, and a second position. In the latter, it holds the cutter in the non-active position, so that by the effect of gravity and/or by the inflowing crop, it reaches an inactive position in which it does not extend into the channel.

The engagement formation, for example the complementary engagement formation, may be configured to maintain the engagement between the lever and the cutter, preferably the cutter body, particularly preferably the second recess, in the first and/or second position and all intermediate positions between the first and second positions, and to allow a release of the positioning device from the cutter, preferably the cutter body, particularly preferably the second recess, in the third position. The engagement formation may comprise that the lever has for example a region, in particular a flattened region, or a latch, which interacts with the second recess, in particular with a complementarily shaped second recess, in the cutter. For example, the lever can then pass through the second recess when it is in a certain position. Advantageously, the positioning device may thus be structurally configured in a simple manner.

In one implementation of the disclosure, the switching shaft is arranged on, preferably supported on and/or connected to the cutting device, for example, the frame cutting device, so as to be rotatable around an axis running parallel to the pivot axis. The lever or levers may be connected to the switching shaft, for example, connected in a rotationally fixed fashion.

In one implementation of the disclosure, the cutter is movable, by means of or via the switching shaft cooperating with the lever, into the first and/or second position and/or all intermediate positions between the first and the second positions. For example, the cutter may be movable into the first and/or second position and/or all intermediate positions between the first and second positions, by rotation of the switching shaft.

In one implementation of the disclosure, the cutting device comprises an actuator. The actuator may be movable between a first position, in which the positioning device, for example, the lever, is in the first position, and a second position, in which the positioning device, for example, the lever, is in the second position, and a third position in which the positioning device, for example, the lever, is in the third position. The actuator may be connected to the switching shaft; the actuator and the switching shaft may be connected to one another by means of or via a coupling element. The cutting device thus may comprise an actuator activated by external force. The actuator may be designed, for example, in the form of a hydraulic cylinder or pneumatic cylinder or threaded drive or rack-and-pinion mechanism or electric cylinder. The actuator may be configured so as to be hydraulically, electromechanically, electromagnetically or for example also pneumatically activatable. In this way, the cutting device can be structured in a relative simple and cost-effective manner, and is less susceptible to wear than in the prior art.

The disclosure furthermore relates to an agricultural harvester with a cutting device. The cutting device according to the disclosure can be used on any harvester, for example for straw-like crops. Examples include loading wagons and balers for round or rectangular bales.

The baler may be a square baler for forming square bales from crop, or a round baler for forming round bales from crop. The baler can comprise a baler frame. The baler can be supported on the ground by wheels. The baling unit of the baler may comprise a baling chamber, for example, a variable-size baling chamber or a variable baling chamber. The baler with a variable-size baling chamber may comprise one or more baling means, wherein the baling means may be configured as a belt or strap or chain assembly or band. The baling means can be driven indirectly in the variable-size baler, for example, via rollers and/or chains and/or shafts and/or gearwheels, for example, using the drive unit. The baler may equally also comprise a size-invariable baling chamber. In this instance, a baling means may be in the form of a baling roller, for example, a multiplicity of baling rollers running parallel to one another, for baling the crop. The axes of rotation of the baling rollers can lie on an arc in the case of a closed ejection unit, and at least one of the baling rollers can be driven. The arrangement of the baling rollers in the baling chamber may correspond to a cylindrical shape, such that the baling rollers are arranged cylindrically around the round bale and form a cylindrical circumferential surface. In the size-invariable baler, the baling means can be driven, for example, via chains and/or shafts and/or gearwheels, for example, using a drive unit. The baler may comprise a pick-up unit, i.e., a pick-up, for collecting crop. The pick-up unit can collect the crop. The baler may moreover comprise a conveyor unit, for example a rotor and/or a conveyor belt.

The bale can be shaped by means of the baling unit, for example, in a compressing phase. The baler may comprise a wrapping unit for wrapping the fully formed bale with a wrapping material, for example a mesh, film or twine. The fully formed bale can be wrapped with the wrapping material, for example, in the baling unit or baling chamber. The baler can comprise an ejection unit, for example an ejection flap or a rear part or a rear flap of the baler. The bale, preferably the fully formed bale or the fully wrapped bale, can be unloaded or ejected via the ejection unit, for example, via the baling unit or baling chamber provided with the ejection unit. The ejection unit can comprise part of the baling chamber, for example, part of the baling means, and/or be formed as part of the baling chamber. The baling chamber may be arranged on the baler frame, preferably connected thereto and/or fastened thereto. The pick-up unit for picking up or for collecting crop lying or standing on a field, and/or for transporting the crop into the baling chamber may likewise be arranged on the baler frame, preferably mechanically connected thereto and/or fastened thereto.

The disclosure furthermore relates to a method for separating a cutter from a cutting device, for example, a cutting device of an agricultural harvester. The method may comprise the following steps. Moving the positioning device into a third position, in which it is detached from the cutter, in order to allow a movement of the cutter independently of the positioning device, and separating the cutter from the cutting device.

The disclosure furthermore relates to a cutter-changing system having a cutter as described herein and a lever element, wherein the cutter-changing system is formed in such a way that, when the lever element engages in the first hole and a force or a radial force is exerted, for example, in the direction of the cutting region or the cutting edge or a radial direction with respect to the pivot axis, the cutter is pivotable around the pivot region, preferably around the first recess, and/or around a pivot shaft of the cutting device.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 shows a schematic illustration of a first example implementation of an agricultural harvester according to the disclosure, with a first example implementation of a cutting device according to the disclosure.

FIG. 2 shows a schematic illustration of a first example implementation of a cutter according to the disclosure.

FIG. 3 shows a schematic illustration of a first example implementation of a lever-cutter system according to the disclosure.

FIG. 4 shows a schematic illustration of the first example implementation of the cutting device according to the disclosure with the positioning device in a first position.

FIG. 5 shows a schematic illustration of the first example implementation of the cutting device according to the disclosure with the positioning device in a second position.

FIG. 6 shows a schematic illustration of the first example implementation of the cutting device according to the disclosure with the positioning device in a third position.

FIG. 7 shows a schematic illustration of a second example implementation of the cutting device according to the disclosure.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

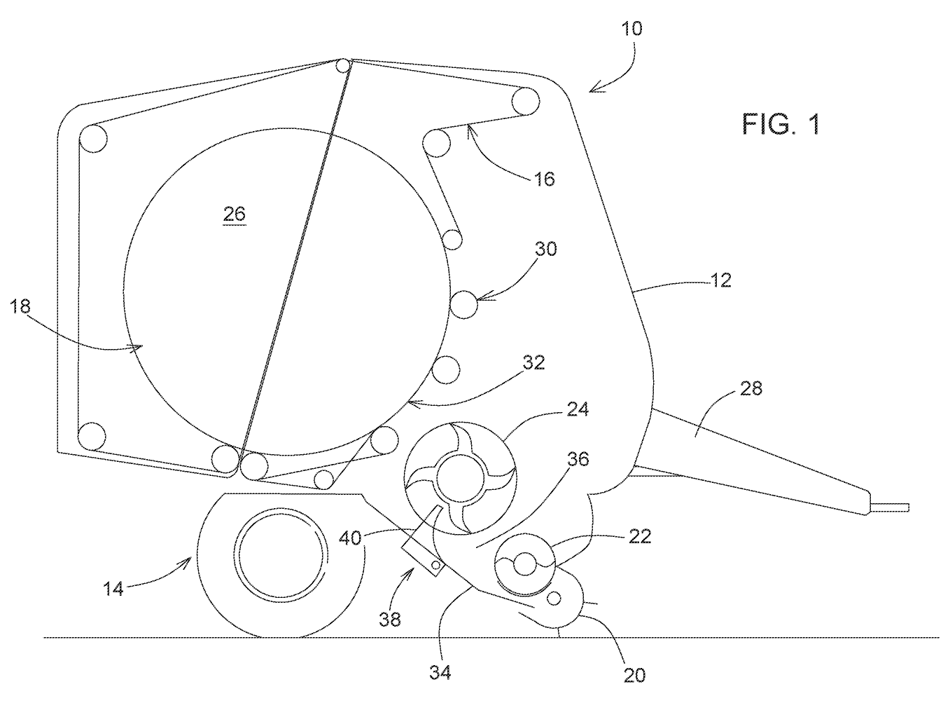

Referring to the Figures, wherein like numerals indicate like parts throughout the several views, FIG. 1 shows a schematic illustration of a first exemplary embodiment of an agricultural harvester according to the disclosure, in the present case a baler 10, with a first exemplary embodiment of a cutting device according to the disclosure.

The baler 10 shown in FIG. 1 has a baler frame 12, a chassis 14, baling means 16, a baling chamber 18, a pick-up unit 20, a conveying unit 22 and a rotor 24. The baler 10 is here representative of every type of baler, i.e. as a round baler with fixed or variable baling chamber volume, with belts, rollers or chains, as a square baler, in agriculture, in industry or in commerce, etc. In the conventional case, such a baler 10 is towed over a field to pick up straw-like crop, such as straw, hay or silage, from the ground and feed it to the baling chamber 18 or to a loading compartment of a loading wagon, in order e.g. to form a bale 26 therein or to store the crop and discharge it at a suitable location. The baler frame 12 contains walls and struts which rest on the chassis 14 and can be attached to a vehicle, e.g. an agricultural tractor, by means of a drawbar 28. The chassis 14 consists of an axle and wheels in conventional fashion.

In the illustrated example implementation, the baling means 16 are formed from belts which are guided via or combined with rollers 30. These baling means 16 leave a clearance so as to form an inlet 32 for the crop into the baling chamber 18. The baling means 16 can circulate in both directions. In this example implementation, the baling chamber 18 is formed in a constant size, but may however be configured as desired.

The pick-up unit 20, in the present case a pick-up, picks up crop from the ground on which it is deposited in a swath of varying thickness and size, the crop being compressed into a narrower width on the way to the baling chamber 18. The crop picked up by the pick-up unit 20 is compressed by means of the conveying unit 22, which is arranged on its output side and is a transverse conveyor auger composed of a central tube and spirals wound around the tube. The conveying unit 22 then transfers the crop to the underslung rotor 24, which has a central tube and attached flights, and conveys it to the inlet 32. Below the conveying unit 22 and the rotor 24 is a wall 34, preferably an underfloor, particularly preferably a metal sheet, along the top of which the crop is conveyed. The wall 34 may be a rigid wall. Accordingly, a channel 36, through which the crop is conveyed, is situated between the wall 34 and the rotor 24.

Optionally, cutters 40 of a cutting device 38 may be inserted into the channel 36 in order to cut the crop into shorter pieces. The cutting device 38 may comprise several cutters 40 arranged side-by-side (transversely to the flow direction of the crop).

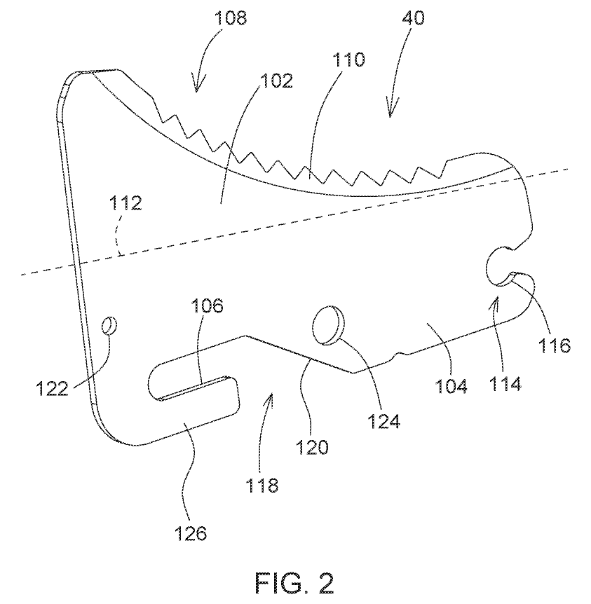

FIG. 2 shows a schematic illustration of the first example implementation of the cutter 40 according to the disclosure. The cutter 40 shown in FIG. 2 substantially corresponds to the cutter 40 shown in FIG. 1, so that only details and/or differences will be discussed below. The harvester shown in FIG. 1, for example, the baler 10, and/or the cutting device 38 may comprise the cutter 40 shown in FIG. 2.

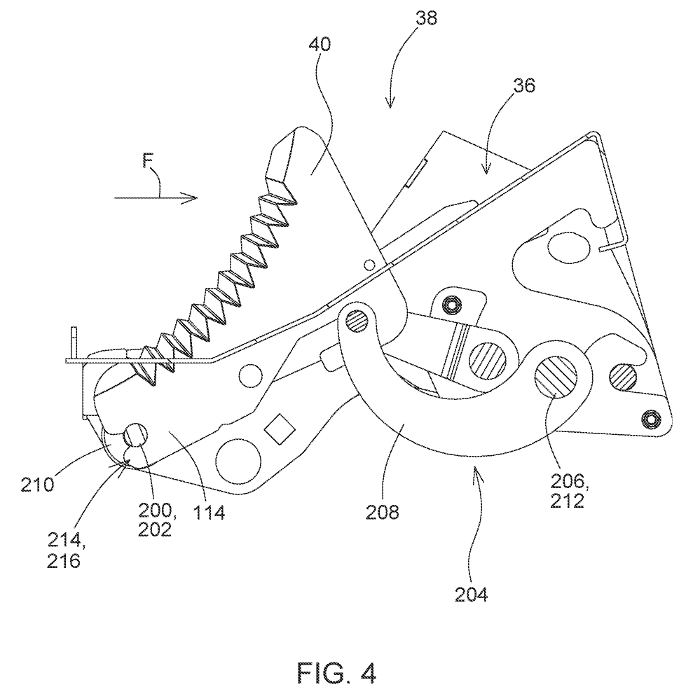

The cutter 40 for a cutting device 38 for an agricultural harvester comprises a cutter body 102 with a first side 104 and a second side 106. The cutter body 102 has a cutting region 108 with a cutting edge 110, wherein the cutting region 108, for example, the cutting edge 110, extends along a longitudinal axis 112 of the cutter body 102. The cutter 40, for example, the cutter body 102, furthermore comprises a pivot region 114 with a first recess 116, and a positioning region 118 with a second recess 120, for the arrangement of the cutter 40 on or in the cutting device 38. The first recess 116 is configured for receiving a pivot shaft 202 (see FIG. 4) of the cutting device 38, and the second recess 120 is configured for receiving a positioning device 204. The cutter 40 has at least a first and second hole 122, 124, for example, one first hole 122 and one second hole 124.

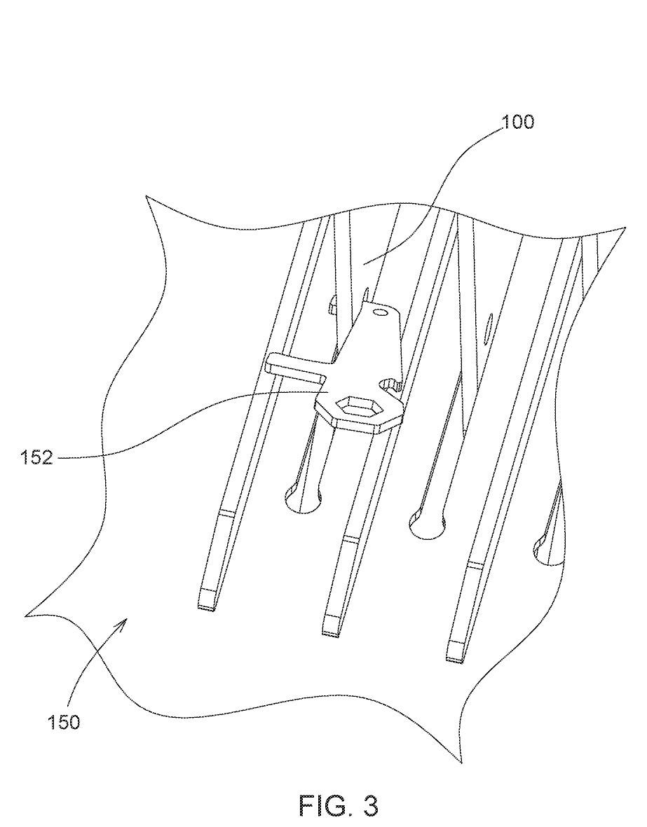

The first hole 122 is configured for receiving a lever element 152 (see FIG. 3). In addition, the first hole 122 may be smaller than the second hole 124. The first and second recesses 116, 120 are open towards the outer contour 126 of the cutter 40. The first and second holes 122, 124 are closed towards the outer contour 126 of the cutter 40, for example, the cutter body 102. The cutting edge 110 has a plurality of teeth.

FIG. 3 shows a schematic illustration of a first exemplary embodiment of the lever-cutter system 150 according to the disclosure. The cutter 40 shown in FIG. 3 substantially corresponds to the cutter 40 shown in FIGS. 1 and 2, so that only details and/or differences will be discussed below. The lever-cutter system 150 comprises the cutter 40 and a lever element 152. The lever-cutter system 150 is designed such that the cutter 40 is pivotable around the pivot region 114, preferably around the first recess 116, and/or around a pivot shaft 202 of the cutting device 38, when the lever element 152 engages in the first hole 122 and a force is exerted in the direction of the cutting region 108, for example, of the cutting edge 110.

FIG. 4 shows a schematic illustration of the first exemplary embodiment of the cutting device 38 according to the disclosure with a positioning device 204 in the first position. The cutting device 38 shown in FIG. 4 substantially corresponds to the cutting device 38 shown in FIG. 1, and the cutter 40 shown in FIG. 4 substantially corresponds to the cutter 40 shown in FIGS. 1 to 3, so that only details and/or differences will be discussed below. The harvester shown in FIG. 1, for example, the baler 10, may comprise the cutting device 38 shown in FIG. 4.

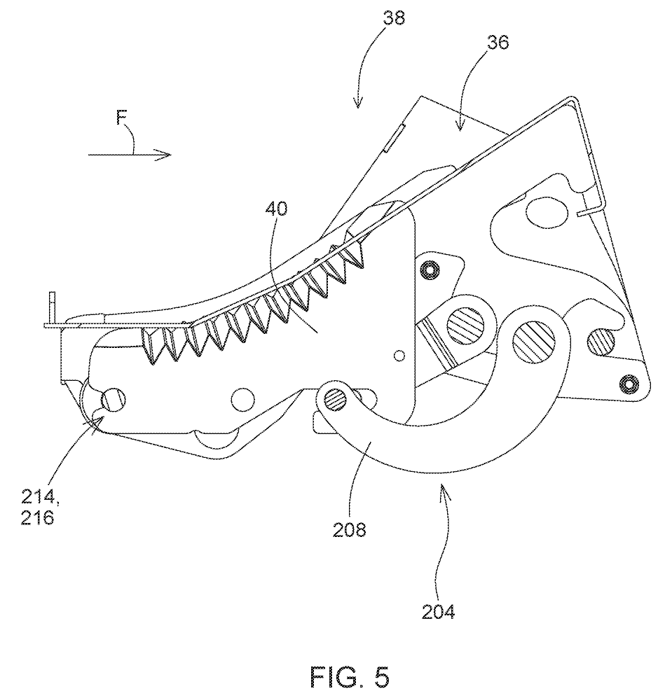

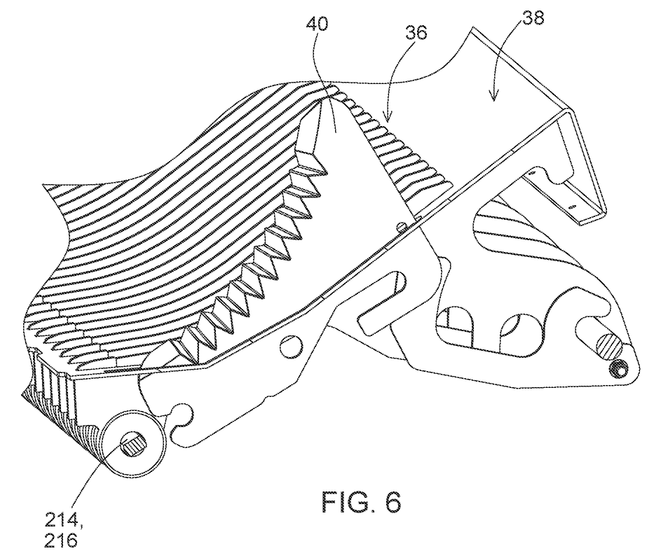

The cutting device 38 comprises at least one cutter 40, preferably several cutters 40, wherein the cutter or cutters 40 is/are arranged in the channel 36 through which the crop can flow. The cutter or cutters 40 is/are connectable or connected to the cutting device 38 so as to be pivotable around a pivot axis 200 extending transversely to the channel 36. The cutting device 38 furthermore comprises a positioning device 204 for setting and/or adjusting the cutter 40 or the cutters 40. The positioning device 204 is settable and/or adjustable between a first position, in which the positioning device 204 sets and/or adjusts the cutter 40 in an active position in which the cutter 40 extends into the channel 36 (shown in FIG. 4), and a second position, in which the positioning device 204 sets and/or adjusts the cutter 40 in the non-active position in which the cutter 40 is pivoted out of the channel 36 (see FIG. 5), and a third position, in which the positioning device 204 is not in engagement with the cutter 40 (see FIG. 6), so as to allow a movement of the cutter independently of the positioning device 204. The cutter 40 is separable from the cutting device 38 when the positioning device 204 is in the third position. The cutting device 38 furthermore comprises a pivot shaft 202, wherein the pivot axis 200 is formed by the pivot shaft 202. In the first position and/or the second position and all intermediate positions between the first and the second positions, the positioning device 204 is connected to the positioning region 118 of the cutter 40. The positioning device 204 comprises a switching shaft 206 and a lever 208. In the first position and/or the second position and all intermediate positions between the first and the second positions, the lever 208 is connected to the positioning region 118 of the cutter 40.

In FIG. 4, the cutting device 38 is shown in a situation in which all cutters 40 are in the active position in which they extend into the channel 36. At their upstream end relative to the flow direction F of the crop, indicated by the arrow, at the pivot region 114, the cutters 40 are arranged on and/or connected to and/or supported on the frame 210 of the cutting device, so as to be pivotable around the pivot axis 200 with the pivot shaft 202. The pivot axis 200 and pivot shaft 202 extend horizontally and/or transversely to the forward direction of the baler 10 and/or transversely to the flow direction F and/or transversely to the channel. Here, the frame 210 of the cutting device may also be the frame of the harvester, for example, the baler 10, i.e. the baler frame 12.

A number of levers 208 corresponding to the number of cutters 40 are individually arranged on, and/or connected to and/or supported on the frame 210 of the cutting device 38, so as to be rotatable around an axis 212 with the switching shaft 206, running parallel to the pivot axis 200. The axis 212 running parallel to the pivot axis 200 may here be formed and/or defined by the switching shaft 206. The levers 208 may be connected, for example, rotationally fixedly connected, to the switching shaft 206. The switching shaft 206 is thus arranged on the cutting device 38 so as to be rotatable around an axis 212 running parallel to the pivot axis 200; for example, the switching shaft 206 may be rotatably arranged or supported on the frame 210 of the cutting device 38. The cutter or cutters 40 may be movable into the first and/or second position and/or all intermediate positions between the first and the second positions, by means of the switching shaft 206 which interacts with the lever 208.

FIGS. 5 and 6 show schematic illustrations of the first exemplary embodiment of the cutting device 38 according to the disclosure. The cutting devices 38 shown in FIGS. 5 and 6 substantially correspond to the cutting device 38 shown in FIGS. 1 and 4, and the cutter 40 shown in FIGS. 5 and 6 substantially corresponds to the cutter 40 shown in FIGS. 1 to 4, so that only details and/or differences will be discussed below. The harvester shown in FIG. 1, for example, the baler 10, may comprise the cutting device 38 shown in FIGS. 5 and 6.

FIG. 5 shows the positioning device 204 in the second position, in which the positioning device 204 sets and/or adjusts the cutter 40 in the non-active position in which the cutter 40 is pivoted out of the channel 36.

FIG. 6 shows the positioning device 204 in the third position, in which the positioning device 204 is not connected to and is not in engagement with the cutter 40, so as to allow a movement of the cutter independently of the positioning device 204.

FIGS. 4 to 6 also show that the pivot shaft 202 and the cutter 40 have a locking formation 214, which in a first configuration locks the cutter 40 on the pivot shaft 202 and in a second configuration allows a separation of the cutter 40 from the pivot shaft 202. For this, the pivot shaft 202 has flattened regions 216 which interact with the first recess 116, which is formed complementarily, of the cutter or cutters 40. The flattened regions 216 of the pivot shaft 202 fit through the first recess when the pivot shaft 202 is in a certain position, for example, the second configuration.

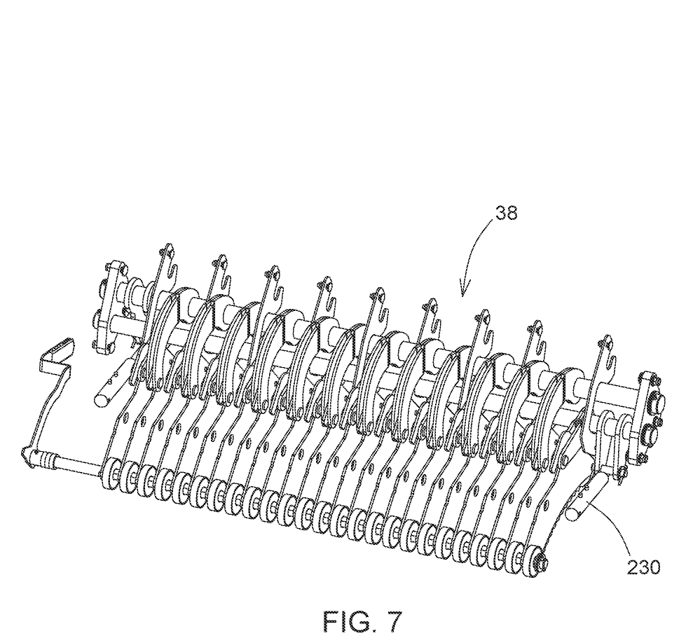

FIG. 7 shows a schematic illustration of a second example implementation of the cutting device 38 according to the disclosure. The cutting device 38 shown in FIG. 7 substantially corresponds to the cutting device 38 shown in FIGS. 1 and 4 to 6, and the cutter 40 shown in FIG. 7 substantially corresponds to the cutter 40 shown in FIGS. 1 to 6, so that only details and/or differences will be discussed below. The harvester shown in FIG. 1, for example, the baler 10, may comprise the cutting device 38 shown in FIG. 7.

The cutting device 38 comprises an actuator 230. The actuator 230 is movable between a first position, in which the positioning device 204, for example, the lever 208, is in the first position, and a second position, in which the positioning device 204, for example, the lever 208, is in the second position, and a third position, in which the positioning device 204, for example, the lever 208, is in the third position.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A cutter for a cutting device of an agricultural harvester, the cutter comprising:
a cutter body having a first side and a second side;
wherein the cutter body has a cutting region with a cutting edge extending along a longitudinal axis of the cutter body;
wherein the cutter body includes a pivot region with a first recess configured for receiving a pivot shaft of the cutting device, and a positioning region with a second recess configured for receiving a positioning device;
wherein the cutter body includes a first hole arranged opposite the pivot region along the longitudinal axis and configured for receiving a lever element therein; and
wherein the cutter body includes a second hole arranged proximate the positioning region along the longitudinal axis.

2. The cutter set forth in claim 1, wherein the first hole is smaller than the second hole.

3. The cutter set forth in claim 1, wherein the first recess and the second recess are each open towards the outer contour of the cutter body, and wherein the first hole and the second hole are each closed with respect to the outer contour of the cutter body.

4. The cutter set forth in claim 1, wherein the cutting edge has a plurality of teeth.

5. A cutting device for an agricultural harvester, the cutting device comprising:
a frame;
a cutter arranged in a channel through which crop can flow, the cutter including a cutter body having a first side and a second side;
wherein the cutter body has a cutting region with a cutting edge extending along a longitudinal axis of the cutter body;
wherein the cutter body includes a pivot region with a first recess configured for receiving a pivot shaft, and a positioning region with a second recess configured for receiving a positioning device;
wherein the cutter body includes a first hole arranged opposite the pivot region along the longitudinal axis and configured for receiving a lever element therein;
wherein the cutter body includes a second hole arranged proximate the positioning region along the longitudinal axis;
wherein the cutter is connectable to the frame so as to be pivotable around a pivot axis extending transversely to the channel; and
wherein the positioning device is adjustable between a first position, in which the positioning device sets the cutter in an active position in which the cutter extends into the channel, and a second position, in which the positioning device sets the cutter in a non-active position in which the cutter is retracted from the channel, and a third position, in which the positioning device is not in engagement with the cutter, so as to allow a movement of the cutter independently of the positioning device;
wherein the cutter is separable from the cutting device when the positioning device is in the third position.

6. The cutting device set forth in claim 5, wherein the pivot shaft and the cutter have a locking formation, which in a first configuration locks the cutter on the pivot shaft and in a second configuration allows separation of the cutter from the pivot shaft.

7. The cutting device set forth in claim 5, wherein in the first position and the second position and in all intermediate positions between the first and the second positions, the positioning device is connected to the positioning region of the cutter.

8. The cutting device set forth in claim 5, wherein the positioning device comprises a switching shaft and the lever, and wherein when disposed in the first position and the second position and in all intermediate positions between the first and second positions, the lever is connected to the positioning region of the cutter via the first hole.

9. The cutting device set forth in claim 8, wherein the switching shaft is arranged on the cutting device so as to be rotatable around an axis running parallel to the pivot axis.

10. The cutting device set forth in claim 8, wherein the cutter is movable into the first and second position and into all intermediate positions between the first and the second positions by means of the switching shaft, which interacts with the lever.

11. The cutting device set forth in claim 5, further comprising an actuator movable between a first position, in which the positioning device is in the first position, and a second position, in which the positioning device is in the second position, and a third position, in which the positioning device is in the third position.

12. The cutter device set forth in claim 5, wherein the first hole of the cutter body is smaller than the second hole of the cutter body.

13. The cutter device set forth in claim 5, wherein the first recess of the cutter body and the second recess of the cutter body are each open towards an outer contour of the cutter body, and wherein the first hole and the second hole are each closed with respect to the outer contour of the cutter body.
